(19) United States
(12) Patent Application Publication
(10) Pub. No.: US 2025/0057253 A1
(43) Pub. Date: Feb. 20, 2025

(54) RADIO FREQUENCY TRANSMITTER FOR PROVIDING POWER TO AN AEROSOL PROVISION DEVICE

(71) Applicant: NICOVENTURES TRADING LIMITED, London (GB)

(72) Inventors: Mohammed AL-AMIN, London (GB); Damyn MUSGRAVE, London (GB); Connor BRUTON, London (GB)

(21) Appl. No.: 18/717,842

(22) PCT Filed: Dec. 8, 2022
(86) PCT No.: PCT/GB2022/053134

§ 371 Date: Jun. 7, 2024

(30) Foreign Application Priority Data
Dec. 9, 2021 (GB) 2117818.1

(51) Int. Cl. A24F 40/90; A24F 40/51; A24F 40/65; H02J 7/00

(52) U.S. Cl. CPC A24F 40/90; A24F 40/51; A24F 40/65; H02J 7/00034

(57) ABSTRACT

A radio frequency transmitter is described comprising: a signal generator configured to generate radio frequency signals; and an antenna configured to transmit the generated radio frequency signals to an aerosol provision device in the vicinity of the radio frequency transmitter.

### TECHNICAL FIELD

The present specification relates to a radio frequency transmitter; for example to a radio frequency transmitter for transmitting radio frequency signals to an aerosol provision device as part of a radio frequency charging system.

### BACKGROUND

Smoking articles, such as cigarettes, cigars and the like burn tobacco during use to create tobacco smoke. Attempts have been made to provide alternatives to these articles by creating products that release compounds without combusting. For example, tobacco heating devices heat an aerosol provision substrate such as tobacco to form an aerosol by heating, but not burning, the substrate. An aerosol provision device may be provided with a case, such as a carry case, for retaining the device when not in use. There remains a need for further developments in this field.

### SUMMARY

In a first aspect, this specification describes a radio frequency transmitter comprising: a signal generator configured to generate radio frequency signals; and an antenna configured to transmit the generated radio frequency signals to an aerosol provision device in the vicinity of the radio frequency transmitter. The radio frequency signals may be for providing power to the aerosol provision device. The antenna may be configured to transmit and/or receive data.

The radio frequency transmitter may further comprise a connector configured to connect to a vehicle power outlet. The connector may be configured to connect to a cigarette lighter, a USB outlet or an AC port.

The radio frequency transmitter may further comprise a sensor (e.g. a proximity sensor), wherein the sensor is configured to detect a presence of an aerosol provision device in the vicinity of the radio frequency transmitter, and output a signal indicative of the presence of said aerosol provision device for use in triggering the transmission of said radio frequency signals to the aerosol provision device in the vicinity of said radio frequency transmitter.

In a second aspect, this specification describes light fixture comprising a radio frequency transmitter as described above with reference to the first aspect. The light fixture may further comprise a light emitter and means for attachment to a surface. The light fixture may further comprise a sensor (e.g. a proximity sensor), wherein the sensor is configured to detect a presence of an aerosol provision device in the vicinity of the radio frequency transmitter, and output a signal indicative of the presence of said aerosol provision device for use in triggering the transmission of said radio frequency signals to the aerosol provision device in the vicinity of said radio frequency transmitter.

In a third aspect, this specification describes a case (e.g. a carry case and/or a charging case) comprising a radio frequency transmitter as described above with reference to the first aspect. The case may be configured to receive the aerosol provision device.

The case may comprise a battery and said radio frequency transmitter may be powered by said battery.

The case may further comprise a case antenna for receiving radio frequency signals and a charging controller configured to charge the battery of said case with power extracted from the radio frequency signals received by said case antenna. The case antenna may be formed from at least part of a metal casing of the case.

The case may further comprise a/the charging controller configured to charge the battery of said case with power obtained from a power input. The power input may receive power from one or more of a solar power generator, an induction power generator and mains power.

The case may further comprise a control module configured to control charging the aerosol provision device directly from said battery when said aerosol provision device is received within said case. The control module may be configured to disable said radio frequency transmitter when said aerosol provision device is received within said case.

The case may further comprise a sensor (e.g. a proximity sensor), wherein the sensor is configured to detect a presence of an aerosol provision device in the vicinity of the radio frequency transmitter, and output a signal indicative of the presence of said aerosol provision device for use in triggering the transmission of said radio frequency signals to the aerosol provision device in the vicinity of said radio frequency transmitter.

### BRIEF DESCRIPTION OF THE DRAWINGS

Example embodiments will now be described, by way of example only, with reference to the following schematic drawings, in which:

FIG. 1 is a block diagram of a non-combustible aerosol provision device in accordance with an example embodiment;

FIGS. 2 and 3 are block diagrams of systems in accordance with example embodiments;

FIGS. 4 and 5 are block diagrams of radio frequency transmitters in accordance with example embodiments;

FIGS. 6 and 7 show vehicle dashboards in accordance with example embodiments;

FIG. 8 is a block diagram of a system in accordance with an example embodiment;

FIG. 9 shows a light fixture in accordance with an example embodiment.

FIG. 10 shows a case for an aerosol delivery device in accordance with an example embodiment;

FIG. 11 is a block diagram of a system in accordance with an example embodiment; and

FIG. 12 is a flow chart showing a use of the system of FIG. 11 in accordance with an example embodiment.

### DETAILED DESCRIPTION

As used herein, the term “delivery system” is intended to encompass systems that deliver at least one substance to a user, and includes non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

According to the present disclosure, a “combustible” aerosol provision system is one where a constituent aerosol-generating material of the aerosol provision system (or component thereof) is combusted or burned during use in order to facilitate delivery of at least one substance to a user.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be an aerosol-generating material or a material that is not intended to be aerosolised. As appropriate, either material may comprise one or more active constituents, one or more flavours, one or more aerosol-former materials, and/or one or more other functional materials.

In some embodiments, the substance to be delivered comprises an active substance. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In one embodiment, the active substance is a legally permissible recreational drug. In some embodiments, the active substance comprises nicotine. In some embodiments, the active substance comprises caffeine, melatonin or vitamin B12. In some embodiments, the active substance comprises or is derived from one or more botanicals or constituents, derivatives or extracts thereof and the botanical is tobacco. In some embodiments, the substance to be delivered comprises a flavour.

Aerosol-generating material is a material that is capable of generating aerosol, for example when heated, irradiated or energized in any other way. Aerosol-generating material may, for example, be in the form of a solid, liquid or gel which may or may not contain an active substance and/or flavourants.

The aerosol-generating material may be an “amorphous solid”. In some embodiments, the amorphous solid is a “monolithic solid”. The aerosol-generating material may be non-fibrous or fibrous. In some embodiments, the aerosol-generating material may be a dried gel. The aerosol-generating material may be a solid material that may retain some fluid, such as liquid, within it. In some embodiments the retained fluid may be water (such as water absorbed from the surroundings of the aerosol-generating material) or the retained fluid may be solvent (such as when the aerosol-generating material is formed from a slurry). In some embodiments, the solvent may be water.

In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavours, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

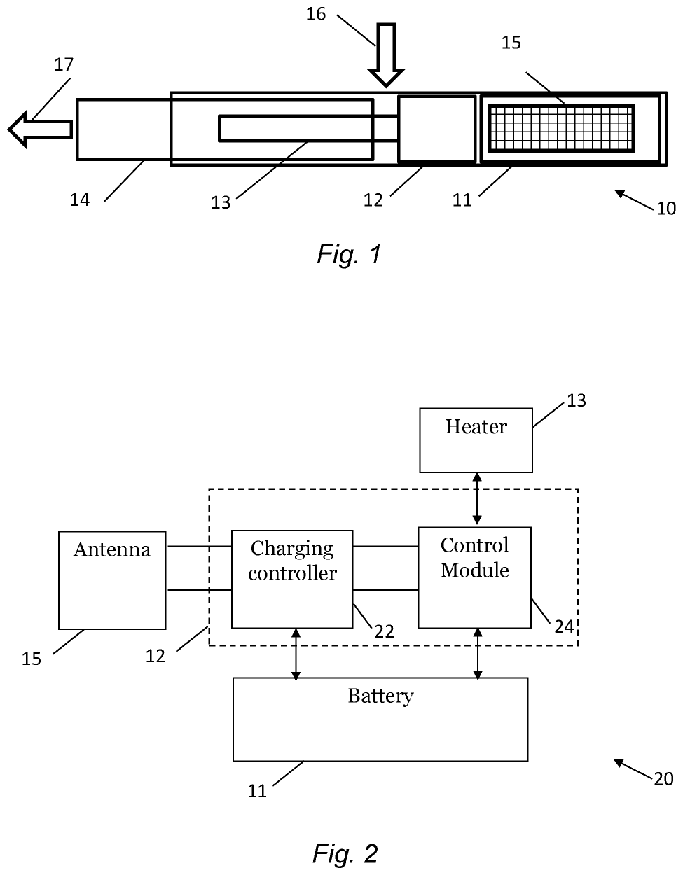

FIG. 1 is a block diagram of a non-combustible aerosol provision device, indicated generally by the reference numeral 10, in accordance with an example embodiment.

The aerosol provision device 10 comprises a battery 11, a control circuit 12, a heater 13 and a consumable 14 (e.g. a tobacco consumable, for example in the form of a tobacco stick). The device also includes an antenna 15. The example antenna 15 is shown provided near the battery 11; however, this is one of many example locations. As discussed in detail below, the antenna may be used to receive radio frequency signals for use in charging the battery 11 (e.g. under the control of the control circuit 12). In addition, the antenna 15 may be used to transmit and/or receive data, for example using one of a number of protocols (e.g. Bluetooth, Wi-Fi etc.).

In the use of the device 10, the heater 13 is inserted into the consumable 14, such that the consumable may be heated to generate an aerosol (and tobacco flavour, in the case of a tobacco consumable) for the user. When a user inhales at the end of the consumable, as indicated by arrow 17, the air is drawn into the device 10, through an air inlet as indicated by arrow 16, then passes through the consumable, delivering the aerosol (and tobacco flavour, in the case of a tobacco consumable) to the user.

The aerosol provision device 10 is described by way of example only. Many alternative aerosol provision devices may be used in example implementations of the principles described here. For example, the device 10 may be replaced within a vaping device in which an aerosol generating material (e.g. a liquid) is heated to generate the aerosol. The principles of the present disclosure are not limited to a particular type of aerosol provision device 10 (that is to say, the aerosol provision device 10 may be arranged to aerosolise a solid, liquid or other aerosol-generating material via any suitable electrically powered or controller aerosol generator, such as a heater, a vibrating mesh, a source of irradiation, an electrically controller pressurised cannister which may include an electrically operated release valve, etc.).

FIG. 2 is a block diagram of a system, indicated generally by the reference numeral 20, in accordance with an example embodiment.

The system 20 comprises the battery 11, the control circuit 12, the heater 13 (or more generally the aerosol generator) and the antenna 15 of the aerosol provision device 10 described above. The control circuit 12 of the system 20 comprises a charging controller 22 and a control module 24.

The antenna 15 may be used to receive radio frequency signals for use in charging the battery 11 (e.g. under the control of the control circuit 12). Furthermore, the charging controller 22 may be configured to charge the battery 11 (e.g. under the control of the control module 24) with power extracted from the received radio frequency signals.

It should be noted that, in some example embodiments, the functionality of the control module 24 is implemented by the charging controller 22. Indeed, the control module 24 may be omitted from some example embodiments. As noted above, the antenna 15 may also be used to transmit and/or receive data.

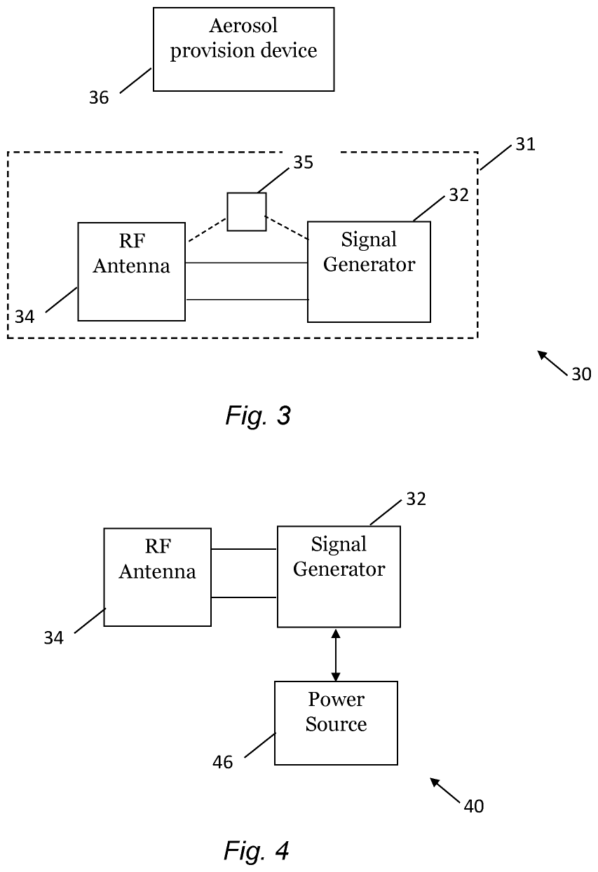

FIG. 3 is a block diagram of a system, indicated generally by the reference numeral 30, in accordance with an example embodiment.

The system 30 comprises a radio frequency transmitter 31 for transmitting radio frequency signals to an aerosol provision device 36 (such as the aerosol provision device 10 described above). The radio frequency transmitter 31 comprises a signal generator 32 and an antenna 34. The signal generator 32 is configured to generate radio frequency signals. The antenna 34 is configured to transmit the generated radio frequency signals to an aerosol provision device 36. The aerosol provision device 36 is in the vicinity of the radio frequency transmitter 31 such that it is possible for the radio frequency transmitter 31 to be in wireless communication with the aerosol provision device 36.

The radio frequency signals transmitted from the radio frequency transmitter 31 to the aerosol provision device 36 are for the purpose of providing power to the aerosol provision device 36. The aerosol provision device may operate using the extracted power from the transmitted radio frequency signals.

The radio frequency transmitter 31 may further comprise a sensor 35 (e.g. a proximity sensor). The sensor 35 is configured to detect the presence of an aerosol provision device (such as the device 36) and output a signal indicative of the presence of an aerosol provision device for use in triggering the transmission of said radio frequency signals to the aerosol provision device in the vicinity of said radio frequency transmitter. For example, the sensor 35 in some implementations may comprise a wireless receiver configured to receive a wireless signal (such as a WiFi or Bluetooth) emitted by the aerosol provision device 36 (e.g. for the purposes of establishing a communications link with the system 30). A control module (not shown) may control activation of the signal generator 32 and/or the RF antenna 34 based on the output of the sensor 35.

FIG. 4 is a block diagram of a radio frequency transmitter, indicated generally by the reference numeral 40, in accordance with an example embodiment. The radio frequency transmitter 40 comprises the signal generator 32 and the antenna 34 of the radio frequency transmitter 31 described above (and may also include the sensor 35). The radio frequency transmitter 40 further comprises a power source 46. The power source 46 is configured to power the operation of the signal generator 32. The power source 46 may take many forms. For example, the power source 46 may include a battery, a supercapacitor, a connection to mains power or an alternative source of power (such as a solar power source or an induction power source), as discussed further below.

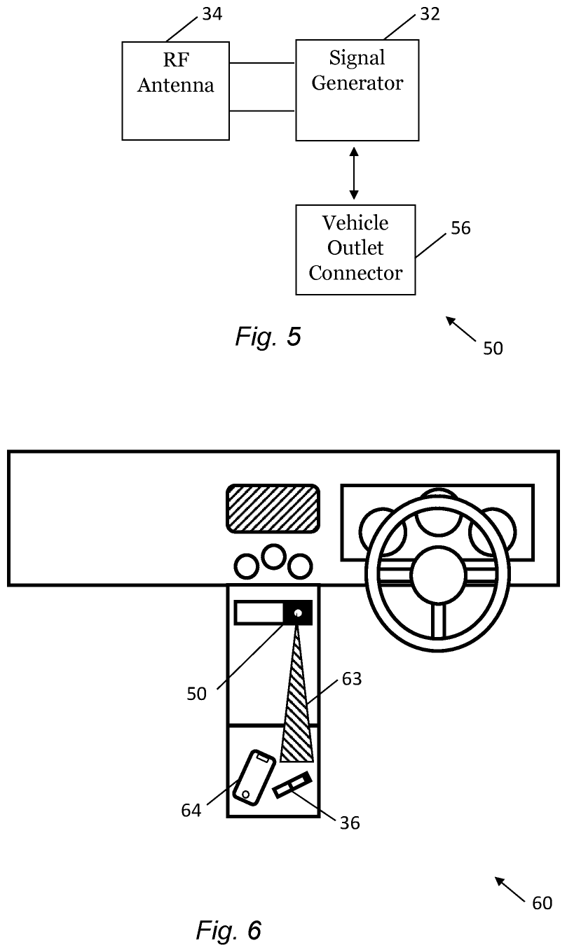

FIG. 5 is a block diagram of a radio frequency transmitter, indicated generally by the reference numeral 50, in accordance with an example embodiment. The radio frequency transmitter 50 comprises the signal generator 32 and the antenna 34 of the radio frequency transmitter 31 described above (and may also include the sensor 35).

As described above, the signal generator 32 is configured to generate radio frequency signals and the antenna 34 is configured to transmit the generated radio frequency signals to an aerosol provision device in the vicinity of the radio frequency transmitter. The radio frequency signals are for providing power to an aerosol provision device.

The radio frequency transmitter 50 further comprises a connector 56 configured to connect to a vehicle power outlet. Connecting the radio frequency transmitter 50 to a vehicle power outlet enables a power source of the vehicle to act as the power source to operate the signal generator 32. The vehicle power outlet connector 56 may be configured to connect to a cigarette lighter, a USB outlet or an AC port (e.g. a 3-pin AC port). The vehicle power outlet connector 56 is therefore an example of the power source 46 of the system 40 described above.

FIG. 6 shows a vehicle dashboard, indicated generally by the reference numeral 60, in accordance with an example embodiment.

The vehicle dashboard 60 includes a power outlet that the radio frequency transmitter 50 described above is connected to. For the example, the radio frequency transmitter 50 (including the signal generator 32 configured to generate radio frequency signals and the antenna 34 configured to transmit the generated radio frequency signals to an aerosol provision device in the vicinity of the radio frequency transmitter) may be connected to a cigarette lighter, a USB outlet or an AC port of the vehicle. The radio frequency signals output by the radio frequency transmitter 50 are for providing power to an aerosol provision device or some other device.

The antenna 34 of the radio frequency transmitter 50 may comprise a directional antenna that produces a directional beam of radio frequency signals 63. The directional antenna may be configured to aim the directional beam of radio frequency signals at a position in the vehicle dashboard that is arranged to store or place devices for charging, such as the aerosol provision device 36 described above. Alternatively, or in addition, the beam 63 may be adjustable dependent on locations of devices for charging that are identified in the vicinity of the dashboard. (That is, the radio frequency transmitter 50 may be configured to output a directional beam 63 based on first identifying the location(s) of the device(s) for changing, and then generating the beam 63, e.g., by controlling one or more antennas making up the antenna 34).

In addition to the aerosol provision device 36 described above, a number of other devices may be charged by the antenna beam. By way of example, a mobile phone 64 is shown positioned for charging in the vehicle dashboard 60.

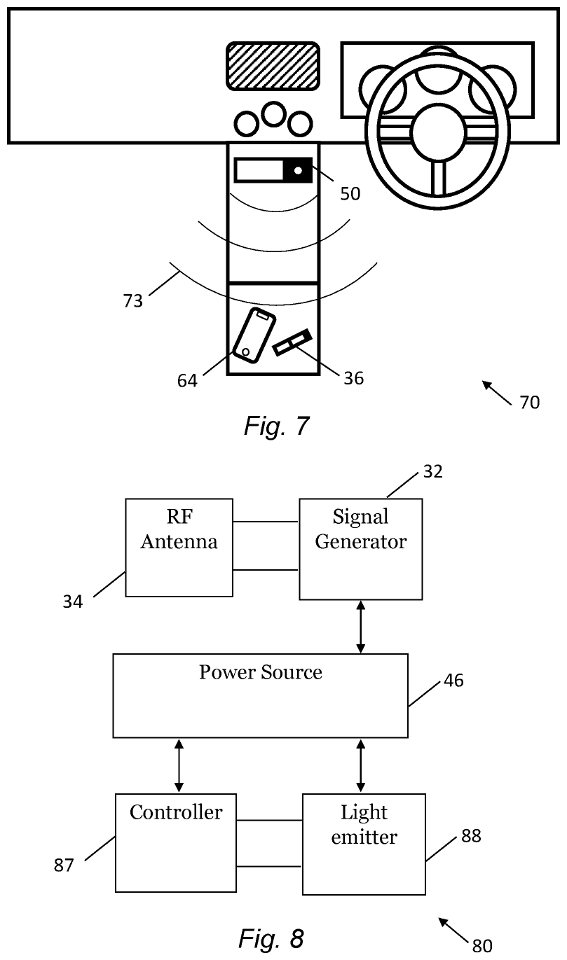

FIG. 7 shows a vehicle dashboard, indicated generally by the reference numeral 70, in accordance with an example embodiment.

The vehicle dashboard 70 comprises a radio frequency transmitter 50 and devices for charging, including the aerosol provision device 36 and the mobile phone 64 described above. In the example vehicle dashboard 70, the antenna 34 comprises an omnidirectional antenna that broadcasts radio frequency signals 73 within a proximity to the radio frequency transmitter 50 to charge an aerosol provision device as well as any other devices 64 capable of extracting power from radio frequency signals 73. Thus, the vehicle dashboards 60 and 70 differ in the nature of the radio frequency outputs of the antenna 34.

The radio frequency transmitters used in conjunction with either the vehicle dashboard 60 or the vehicle dashboard 70 may include a sensor (e.g. a proximity sensor) to detect the presence of a device for charging in the vicinity of the radio frequency transmitter for use in triggering the transmission of radio frequency signals for charging.

FIG. 8 is a block diagram of a system, indicated generally by the reference numeral 80, in accordance with an example embodiment.

The system 80 comprises the signal generator 32, the RF antenna 34 and the power source 46 of the system 40 described above (and may additionally include the sensor 35). The antenna 34 is configured to transmit radio frequency signals generated by the signal generator 32 to a device (such as the aerosol provision device 36 described above) in the vicinity of the antenna (for the purpose of providing power to said device). The sensor 35 (if provided) may be used to trigger the provision of said power to a detected device.

The system 80 further comprises a controller 87 and a light emitter 88. The power source 46 is configured to power the operation of the signal generator 32, the controller 87 and the light emitter 88. The power source may include, but is not limited to a battery, supercapacitor or a connector to mains power or an alternative source of power.

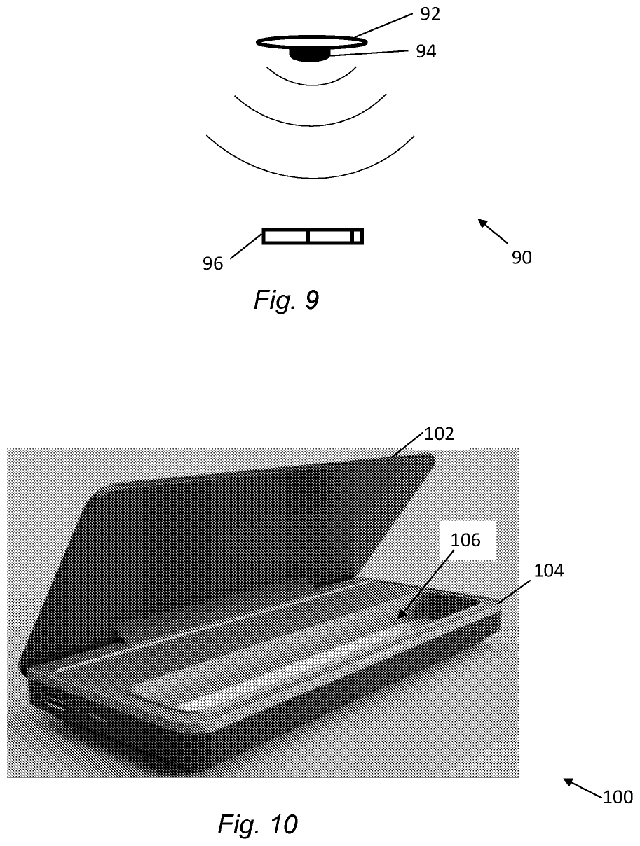

FIG. 9 shows a light fixture, indicated generally by the reference numeral 90, in accordance with an example embodiment.

System 90 shows a light fixture comprising a radio frequency transmitter 92. The light fixture comprises a light emitter 94 (that may be an implementation of the light emitter 88 described above) and means for attachment to a surface (such as screws). The light fixture comprising a radio frequency transmitter 92 is configured to broadcast a radiofrequency signal (shown schematically in FIG. 9) to an aerosol provision device 96.

FIG. 10 shows a case for an aerosol delivery device, indicated generally by the reference numeral 100, in accordance with an example embodiment. The case 100 comprises a lid 102 and a main body 104. The main body 104 includes a storage area 106 for storing an aerosol delivery device (not shown in FIG. 10). The aerosol delivery device may be a non-combustible aerosol generating device, although this is not essential to all example embodiments. For example, the case 100 may be configured to receive any of the aerosol delivery devices 10, 36 and 96 described above.

The case 100 may be a carry case, such that the aerosol generating device can be stored within the case. The case 100 may be a charging case, such that a stored aerosol generating device can be charged.

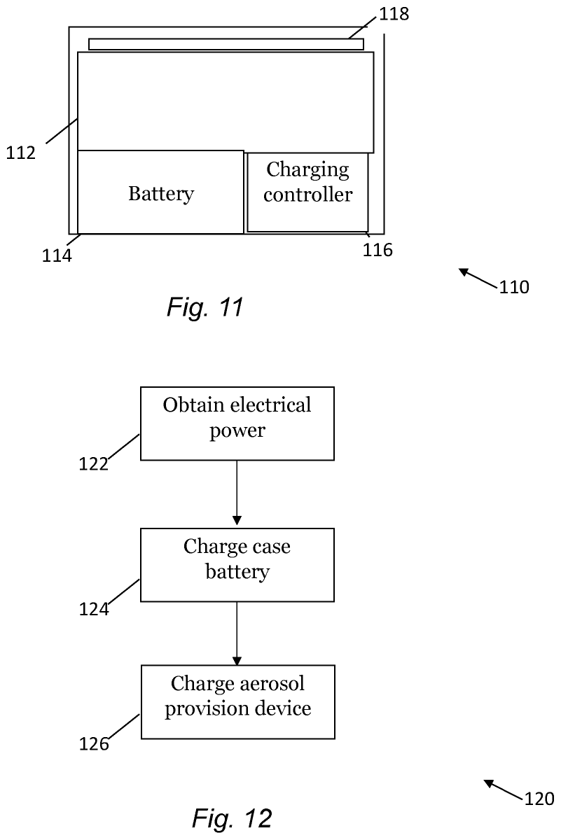

FIG. 11 is a block diagram of a system, indicated generally by the reference numeral 110, in accordance with an example embodiment. The system 110 may form part of the case 100 described above.

The system 110 comprises an area 112 for receiving an aerosol provision device, a charging controller 116 and an antenna 118 for receiving and/or transmitting radio frequency signals and may optionally comprise a battery 114. The area 112 may be the storage area 106 of the case 100 described above. As discussed further below, the charging controller 116 may be configured to charge a battery of the aerosol provision device and/or the battery 114 of the case (if provided) with power extracted from the received radio frequency signals.

The area 112 for receiving the aerosol provision device may include means for electrically coupling to a received aerosol provision device. The said means may take many forms, such as physical electrical connection and/or an inductive coupling.

The antenna 118 may be provided on the exterior of the case (as shown in the system 110), but in some example embodiments, the system 110 may comprise a metal casing which may be used, at least in part, as the antenna. The antenna may be formed from some or all of the metal casing of the case.

FIG. 12 is a high-level schematic flow chart showing a use of the system of FIG. 11 in accordance with an example embodiment.

The algorithm 120 starts at operation 122, where electrical power is obtained. The electrical power may be obtained from an electrical power port of the case 100. Alternatively, or in addition, electrical power may be extracted from radio frequency signals received by the antenna 118.

Next, the battery 114 of the case is charged using electrical power obtained in the operation 122. Note that the operation 122 may be omitted (e.g. if the case does not include the battery 114).

Thus, in one example embodiment, a case antenna (e.g. the antenna 118) is used to receive radio frequency signals and the charging control 116 used to charge the battery 114 of the case with power extracted from the radio frequency signals received by said case antenna.

At operation 126, the charging controller 116 controls the charging of an aerosol provision device. The device may be received within the area 112 or may be outside the case (e.g. in use). The aerosol provision device may be charged with power stored in the battery 114 or may be charged (under the control of the charging controller 116) directly with power extracted from the received radio frequency signals (without the intervening step of using that power to charge the battery 114).

In some example embodiments, the operation 126 may be implemented by transmitting radio frequency signals to the aerosol provision device for charging (e.g. using the case antenna 118). Thus, the antenna 118 may be used for transmitting radio frequency signals under the control of the charging controller (and powered, for example, by the battery 114).

In some example embodiments, the charging controller 116 may control charging of an aerosol provision device directly from said battery when said aerosol provision device is received within a case (e.g. the case 100). Further, the charging controller may disable radio frequency charging of the received aerosol provision device.

As described above, some example transmitter module implementations include an omnidirectional antenna and some other example transmitter module implementations include a directional antenna. In some example embodiments, a transmitter module may be provided including both an omnidirectional antenna and a directional antenna. A mechanism may be provided to decide whether to use the omnidirectional antenna or the directional antenna. Such a mechanism may include a system setting (e.g. a user may indicate whether an omnidirectional or a directional mode of operation should be used). Alternatively, or in addition, the decision mechanism may be based on circumstances; for example, if a small number of devices (e.g. one or two aerosol provision devices) are to be charged, then the directional antenna may be used, but if multiple devices are to be charged (e.g. more than two), then the omnidirectional antenna may be used. Alternatively, or in addition, the decision mechanism may be dependent on whether (or how accurately) positions of devices to be charged can be determined.

As discussed above, electrical power may be extracted from radio frequency (RF) signals. This may be implemented in a number of ways. For example, a receiving antenna may be provided to receive the RF signals, causing a potential difference to occur across the length of the antenna. Thus, an AC (typically sinusoidal) RF signal is obtained at the antenna. This AC signal is typically converted into a DC signal, for example using a rectifier circuit (such as a full bridge or half-bridge rectifier circuit). In some example embodiments, an impedance matching circuit is provided between the antenna and a rectifier circuit that seeks to maximise power transfer from the antenna to the rectifier. The DC electrical power output by the rectifier may, for example, be stored using a battery.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A radio frequency transmitter comprising:
a signal generator configured to generate radio frequency signals; and
an antenna configured to transmit the generated radio frequency signals to an aerosol provision device in the vicinity of the radio frequency transmitter.

2. The radio frequency transmitter as claimed in claim 1, wherein the radio frequency signals are for providing power to the aerosol provision device.

3. The radio frequency transmitter as claimed in claim 1, further comprising:
a connector configured to connect to a vehicle power outlet.

4. The radio frequency transmitter as claimed in claim 3, wherein the connector is configured to connect to a cigarette lighter, a USB outlet or an AC port.

5. The radio frequency transmitter as claimed in claim 1, wherein the antenna is configured to transmit and/or receive data.

6. A light fixture comprising the radio frequency transmitter as claimed in claim 1.

7. A light fixture as claimed in claim 6, further comprising:
a light emitter; and
means for attachment to a surface.

8. A case comprising the radio frequency transmitter as claimed in claim 1, wherein the case is configured to receive the aerosol provision device.

9. The case as claimed in claim 8, wherein the case is a carry case and/or a charging case.

10. The case as claimed in claim 8, wherein:
the case comprises a battery; and
the radio frequency transmitter is powered by said battery.

11. The case as claimed in claim 10, further comprising:
a case antenna for receiving radio frequency signals; and
a charging controller configured to charge the battery of said case with power extracted from the radio frequency signals received by said case antenna.

12. The case as claimed in claim 11, wherein the case antenna is formed from at least part of a metal casing of the case.

13. The case as claimed in claim 10, further comprising:
the charging controller configured to charge the battery of said case with power obtained from a power input.

14. The case as claimed in claim 13, wherein the power input receives power from one or more of a solar power generator, an induction power generator and mains power.

15. The case as claimed in claim 10, further comprising:
a control module configured to control charging the aerosol provision device directly from said battery when said aerosol provision device is received within said case.

16. The case as claimed in claim 15, wherein said control module is configured to disable said radio frequency transmitter when said aerosol provision device is received within said case.

17. The radio frequency transmitter as claimed in claim 1, further comprising:
a sensor, wherein the sensor is configured to detect a presence of an aerosol provision device in the vicinity of the radio frequency transmitter, and output a signal indicative of the presence of said aerosol provision device for use in triggering the transmission of said radio frequency signals to the aerosol provision device in the vicinity of said radio frequency transmitter.

18. The radio frequency transmitter as claimed in claim 17, wherein the sensor is a proximity sensor.
